(19) United States
(12) Patent Application Publication
(10) Pub. No.: US 2026/0105394 A1
(43) Pub. Date: Apr. 16, 2026

(54) SYSTEMS AND METHODS FOR CONTEXT-AWARE TASK EXECUTION AND ADAPTIVE RESPONSE GENERATION USING ARTIFICIAL INTELLIGENCE AGENTS

(71) Applicant: ACCENTURE GLOBAL SOLUTIONS LIMITED, Dublin 4 (IE)

(72) Inventors: Duncan James GILLIES, Queensland (AU); Sarthak DAS, Notting Hill (AU); George Costa KARSAS, Merrimac (AU)

(73) Assignee: ACCENTURE GLOBAL SOLUTIONS LIMITED, Dublin 4 (IE)

(21) Appl. No.: 19/358,134

(22) Filed: Oct. 14, 2025

Related U.S. Application Data
(60) Provisional application No. 63/707,578, filed on Oct. 15, 2024.

(51) Int. Cl. G06Q 10/0631; G06F 11/34

(52) U.S. Cl. CPC G06Q 10/06316; G06F 11/3409

(57) ABSTRACT

Systems and methods for context-aware task execution and adaptive response generation using Artificial Intelligence (AI) agents are disclosed. In an aspect, a user input for performing a task is received. Further, a context and operations required for performing the task are determined. Furthermore, an AI agent is determined to perform the task based on the context, a task type, metadata and the operations. Moreover, resources required for performing the task are determined based on the AI agent and the operations. A Generative AI (Gen AI) model and configuration parameters for the AI agent are then identified. Also, an execution sequence is determined for performing the task based on the Gen AI model and the configuration parameters. The task is then executed at the AI agent and a response to the user input is then generated. Also, the response is outputted on a user interface of a user device.

### CROSS-REFERENCE TO RELATED APPLICATION(S)

This application claims priority under 35 USC § 119(e) to a U.S. Provisional Application No. 63/707,578, filed on Oct. 15, 2024, the entire content of which is hereby incorporated by reference in the entirety for all purposes.

### TECHNICAL FIELD

Various examples described herein relate generally to systems and methods for task execution and response generation. Specifically, the disclosed examples are directed to techniques for context-aware task execution and adaptive response generation using Artificial Intelligence (AI) agents.

### BACKGROUND

The advancement of Artificial Intelligence (AI) technologies has resulted in development of multiple open-source multi-agent frameworks. The frameworks may offer distinct capabilities in areas, such as in-memory management, tool and skill integration, prompt handling, agent instantiation, and interaction protocols. Implementation of the capabilities varies significantly across frameworks, leading to fragmentation within the multi-agent ecosystem. As a result, significant time and effort may be dedicated to understanding architecture and operational paradigms of each individual framework prior to effective deployment. Also, existing multi-agent systems lack a standardized mechanism for integrating or combining the capabilities of the multiple frameworks. Therefore, the existing multi-agent systems may restrict architectural flexibility, increase development complexity, and limit overall system scalability. The restrictions may further limit generalizability and reduce the reusability of components across varied enterprise workflows and system environments.

### SUMMARY

Implementations of the present disclosure are generally directed to systems and methods for task execution and response generation. Specifically, the disclosed examples are directed to techniques for context-aware task execution and adaptive response generation using Artificial Intelligence (AI) agents.

In some examples, aspects of the subject matter described herein provide a system including a processor, and a memory communicably coupled to the processor, wherein the memory comprises processor-executable instructions which, when executed by the processor, cause the processor to receive a user input for performing at least one task from at least one data source, wherein the user input comprises at least one of a question, a workflow request, and an action. Further, the processor may determine a context and a plurality of operations required for performing the at least one task based on a task type, and metadata associated with the at least one task using an AI model, wherein the metadata comprises domain information, policy information, and sensitivity information. Furthermore, the processor may determine at least one AI agent to perform the at least one task based on the determined context, the task type, the metadata associated with the at least one task and the plurality of operations required for performing the at least one task. In addition, the processor may determine a plurality of resources required for performing the at least one task based on the determined at least one AI agent and the plurality of operations required for performing the at least one task, wherein the plurality of resources comprise operational resources, network resources, computational resources, and data storage resources.

Moreover, the processor may identify a Generative Artificial Intelligence (Gen AI) model and configuration parameters for the determined at least one AI agent based on the determined plurality of resources, wherein the configuration parameters comprise a model family, a context window, a temperature value, and safety settings. Also, the processor may determine an execution sequence for performing the at least one task based on the identified Gen AI model and the configuration parameters. The processor may then execute the at least one task at the at least one AI agent based on the determined execution sequence, the identified Gen AI model, and the configuration parameters. Further, the processor may generate a response to the user input based on results of execution of the at least one task at the at least one AI agent, wherein the response comprises at least one of a formatted answer, a processed dataset, an actionable output, a report, and wherein the response aligns with the task type and user requirements. Also, the processor may output the generated response on a user interface of a user device.

The present disclosure further describes a method, executed by the processor provided herein, for context-aware task execution and adaptive response generation using the AI agents as described with respect to the system herein. The present disclosure also describes non-transitory computer-readable medium coupled to the processor and having instructions stored thereon which, when executed by the processor, cause the processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of a task execution and response generation system, in accordance with implementations of the present disclosure.

FIG. 3 depicts an example architecture of an Artificial Intelligence (AI)-based multi-agent abstraction framework, in accordance with implementations of the present disclosure.

FIG. 4 depicts an example process flow for context-aware task execution and adaptive response generation using the AI-based multi-agent abstraction framework, in accordance with implementations of the present disclosure.

FIG. 5 is a flow diagram that represents an example method for context-aware task execution and adaptive response generation using Artificial Intelligence (AI) agents, in accordance with implementations of the present disclosure.

FIG. 6 depicts a block diagram of an example computer system that may be used to implement the method for context-aware task execution and adaptive response generation using AI agents, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Implementations of the present disclosure provides a unified, configuration-driven platform abstraction for AI-based multi-agent systems. Also, the present disclosure enables seamless integration with multiple open-source multi-agent environments, allowing developers to leverage or combine capabilities from different sources without modifying core application logic. Also, the implementations of the present disclosure may support agent creation, configuration, and orchestration through reusable archetypes and a modular, extensible catalog of tools. Therefore, the AI-based multi-agent systems integrates with development environments using minimal configuration, with support for extension to additional languages and platforms.

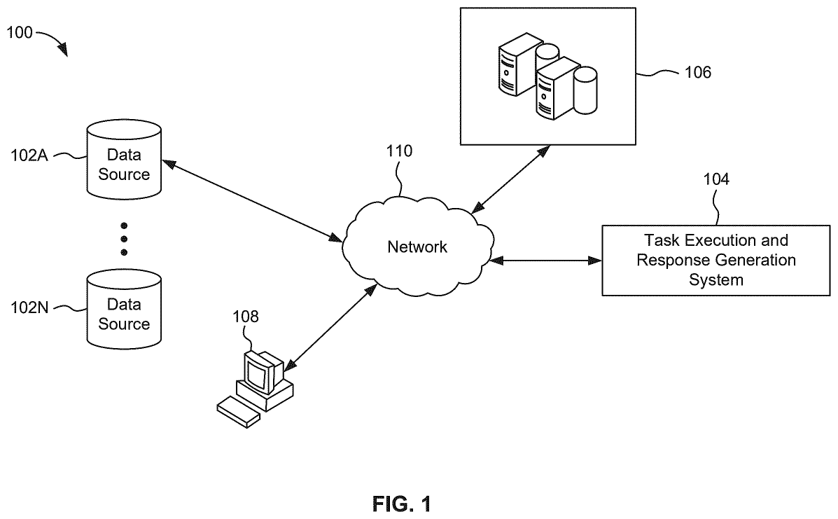

FIG. 1 depicts an example environment 100 that may be used to execute implementations of the present disclosure. The example environment 100, shown in FIG. 1, includes data sources 102A-N, a task execution and response generation system 104, a storage device 106 and a user device 108. For simplicity, a single user device 108 is depicted in FIG. 1, however it should be noted that the example environment 100 may include one or more user devices. The data sources 102A-N, the task execution and response generation system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that includes information corresponding to configuration data associated with AI agents and user inputs for performing one or more tasks. The plurality of data sources 102A-N may include a server such as a web server, a database server, a host server, a proxy server, a virtual server (e.g., executing on a computing hardware), or a server in a cloud computing system.

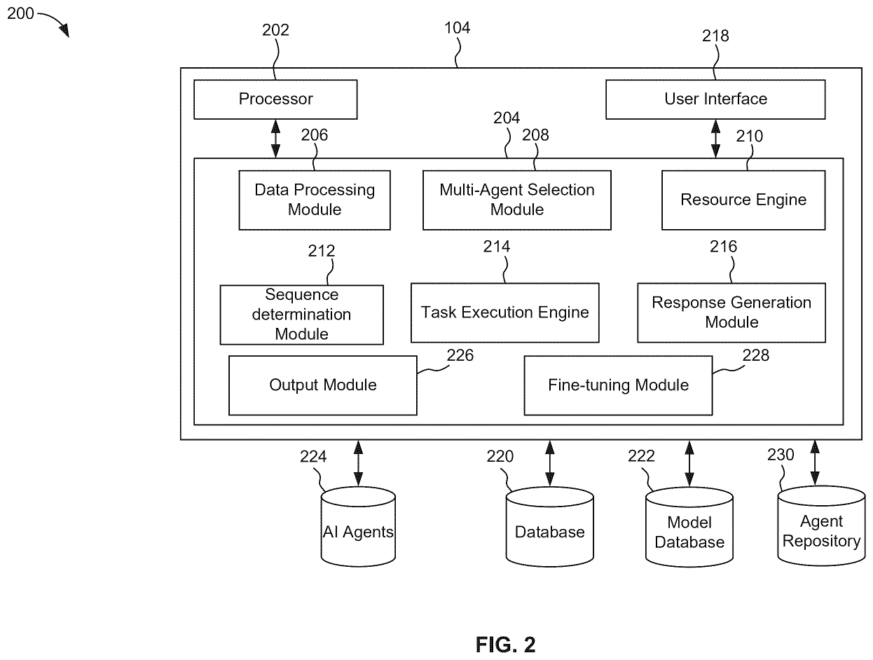

The task execution and response generation system 104 is a computing device or an application server that retrieves or obtains the data from the plurality of data sources 102A-N to perform context-aware task execution and adaptive response generation using the AI agents. The task execution and response generation system 104 may then process and store responses in the storage device 106. In some examples, the task execution and response generation system 104 may include internal or external servers, quantum computers, desktops, laptops, smartphones, tablets, and/or the like. It is contemplated that implementations of the present disclosure may be realized with any appropriate type of computing device or computing platform. In some examples, the task execution and response generation system 104 may display one or more Graphical User Interfaces (GUIs) 218 that enable the user of the user device 108 to interact or provide feedback with a computing platform executing the tasks and generating the responses. Examples of the computing platform may include content delivery platforms, multimedia-based platforms, and/or the like. Interacting with the computing platform may include providing feedback during the process of context-aware task execution and adaptive response generation. For example, the task execution and response generation system 104 is described in more detail with reference to FIG. 2.

While only one task execution and response generation system 104 is shown in FIG. 1, there may be more than one task execution and response generation system 104, and each of the task execution and response generation system 104 includes at least one server system. In some examples, the system hosts one or more computer implemented services that users can interact with by using the user device 108. For example, components of enterprise systems and applications can be hosted on one or more of the task execution and response generation system 104. In some examples, the task execution and response generation system 104 can be provided as an on-premises system that is operated by an enterprise or a third-party taking part in cross-platform interactions and data management. In some examples, the task execution and response generation system 104 can be provided as an off-premises system (e.g., cloud or on-demand) that is operated by an enterprise or a third-party on behalf of an enterprise.

In some examples, the user device 108 may include computer executable applications executed thereon. The user device 108 may include a web browser application executed thereon, which can be used to display one or more web pages of applications executing on the task execution and response generation system 104. In some examples, the user device 108 can display one or more GUIs that enable the respective the users to interact with the task execution and response generation system 104 and/or to present the response generated to the user inputs. In accordance with implementations of the present disclosure, the task execution and response generation system 104 may host enterprise applications or systems that require data sharing and data privacy.

In some implementations, the task execution and response generation system 104 can be implemented in a cloud environment. In the example of FIG. 1, the task execution and response generation system 104 can include various forms of servers including, but not limited to, a web server, a proxy server, a network server, and/or a server pool. In general, server systems accept requests for application services and provide such services to any number of user devices.

Further, the storage device 106 may include any standalone server or any type of computing device that is part of a cloud computing environment for storing data that is ingested by processing the data. Various examples depicting the process of context-aware task execution and adaptive response generation using the AI agents are described in detail in conjunction with FIGS. 2-4.

FIG. 2 depicts an example architecture 200 of the task execution and response generation system 104, in accordance with implementations of the present disclosure. As depicted in FIG. 2, the task execution and response generation system 104 is communicatively coupled to a database 220 (e.g., the storage device 106), a model database 222 and an agent repository 230. For example, the database 220 can be a client database or a metadata database. In some examples, the model database 222 may include one or more Multimodal Large Language Models (multimodal LLMs) (also referenced herein as Gen AI models, foundation models, and/or the like). In an implementation, the LLMs may include pre-trained LLMs and generated LLMs. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the task execution and response generation system 104 includes a processor 202 and a memory 204. The task execution and response generation system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions or processor-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

The system 104 further includes a data processing module 206, a multi-agent selection module 208, a resource engine 210, a sequence determination module 212, a task execution module 214, a response generation module 216, an output module 226 and a fine-tuning module 228 as depicted in FIG. 2. The data processing module 206, the multi-agent selection module 208, the resource engine 210, the sequence determination module 212, the task execution module 214, the response generation module 216, the output module 226 and the fine-tuning module 228 may be stored in the memory 204 and provided as a downloadable library including the computer-readable instructions. The data processing module 206, the multi-agent selection module 208, the resource engine 210, the sequence determination module 212, the task execution module 214, the response generation module 216, the output module 226 and the fine-tuning module 228 may be executed by the processor 202 communicatively coupled with the memory 204 for context-aware task execution and adaptive response generation using AI agents 224. In some examples, the AI agents 224 may include autonomous agents or specialized agents, such as code refactoring agents, market research agents, supplier engagement agents, product evaluation agents, financial analysis agents, category review agents, supply chain agents, pilot testing agents, monitoring agents, vendor negotiation agents, persona agents and the like and are implemented as containerized microservices that execute on external computing devices or within the system 104. The agents 224 are in network communication with various modules and engines in the memory 204 via Application Programming Interfaces (APIs) or message queues. In some examples, the AI agents 224 may be stored in and executed directly from the memory 204 of the system 104. In this case, inter-agent communication may be facilitated via internal process calls, local sockets, or memory buses.

In an example implementation, the data processing module 206 may receive a user input for performing one or more tasks from one or more data sources (i.e., the plurality of data sources 102A-N). For example, the user input may include one or more of a question, a workflow request, and an action. In an aspect, the question may include “What is the status of Project X?”, the workflow request may include “Generate a monthly sales report and send it to the finance team” and the action may include “Delete inactive users from the database”.

Further, the data processing module 206 may determine a context and a plurality of operations required for performing the one or more tasks based on a task type, and metadata associated with the task using an AI model stored in the model database 222. For example, the metadata may include domain information (e.g., healthcare, finance, logistics and the like), policy information (e.g., access control, business rules and the like), and sensitivity information (e.g., data classification levels, Personal Identification Information (PII) tags, or regulatory restrictions). In an example implementation, task constraints and task requirements corresponding to the one or more tasks are identified by extracting a plurality of features from the task type and the metadata. Example features may include task-specific indicators, operational constraints, compliance flags, or domain-specific keywords. Further, in this example implementation, the task type is classified into a plurality of categories based on the identified task constraints and the task requirements. For example, the categories may include a question resolution (e.g., returning factual information or analytical insights), a workflow orchestration (e.g., triggering multi-step processes, executing sequential or parallel sub-tasks), and an action performance (e.g., executing a database update, triggering a notification, or calling an external API).

Furthermore, a task context for the one or more tasks is generated based on the classification. For example, the task context may include environmental constraints (e.g., latency limits, device type, network conditions), compliance rules (e.g., regional data residency, audit requirements and the like), and security protocols (e.g., authentication scopes, encryption policies, access control lists and the like). In addition, the one or more tasks are mapped to the plurality of operations required for execution of the one or more tasks based on the generated task context. For example, the operations are selected from a predefined operation set stored in the database 220 based on the generated task context. In an aspect, the process of mapping may include selecting the plurality of operations from a predefined set based on the task context. For example, the operations may include one or more of data retrieval from specified sources, computational processing (e.g., executing business logic, applying transformation functions, and the like) and accessing memory (e.g., reading from or writing to a state store or temporary cache). The data processing module 206 may instantiate and dynamically configure operation templates stored in an operation library or knowledge base of the database 220 based on specific task requirements and constraints. Thus, the data processing module 206 may process heterogeneous task or user inputs in a scalable, policy-compliant, and secure manner while maintaining extensibility and interoperability across multi-agent frameworks and enterprise environments.

Furthermore, the multi-agent selection module 208 may include determining one or more of the AI agents 224 to perform the task based on the determined context, the task type, the metadata associated with the task and the plurality of operations required for performing the task. In an example implementation, candidate agent configurations are identified from an agent repository (e.g., the agent repository 230) by matching the configuration parameters to the task context, the task type, the metadata, and the plurality of operations. For example, the configuration parameters may include agent capabilities e.g., ability to retrieve data, classify documents, or generate natural language output), operational constraints (e.g., resource usage limits, latency tolerances, security levels, domain constraints and the like) and interface bindings (e.g., APIs, protocol support, data schema alignment). The agent repository 230 may maintain a collection of agent configurations. Each configuration represents a pre-defined or dynamically generated AI agent profile, including details such as the agent's functional capabilities, supported operations, integration constraints, preferred models, toolsets, and environment compatibility. In an aspect, the process of mapping may involve rule-based filters, semantic similarity scoring, or use of AI classifiers that compute compatibility based on historical agent performance or learned embedding vectors. For example, during the process of the rule-based filtering, logical conditions are applied to eliminate non-qualifying configurations based on pre-defined constraints (e.g., resource limits or unsupported operations). During the process of the semantic similarity scoring, contextual embeddings derived from task metadata and agent descriptions are compared using vector-based similarity metrics to determine compatibility. During the AI-based classification, trained models (e.g., neural classifiers, graph neural networks, or transformer-based encoders) are utilized to predict the suitability of a given agent configuration based on historical task-agent performance records, context embeddings, or learned compatibility metrics.

Further, in the example implementation, the identified candidate agent configurations are ranked based on compatibility with the task context, metadata constraints, and alignment with the plurality of operations and available system resources. In an aspect, the rank may be derived using a weighted evaluation function that considers alignment with metadata constraints, compatibility with the task context, support for the required operations, and availability of system resources (e.g., memory, processing time, concurrent usage limits). Furthermore, an appropriate agent configuration is selected for performing the one or more tasks based on the ranked candidate agent configurations. In some examples, a top-ranked agent configuration is selected as the appropriate agent configuration for executing the task.

In addition, functional references defined in the selected appropriate agent configuration are determined. The functional references may include executable functions from specified sources to support task-specific operations. For example, the functions are retrieved via predefined mappings where tasks are directly linked to functions, dependency injection frameworks where dynamically resolve and inject the required service objects or runtime libraries, or API invocation mechanisms where query external or internal services for operational capability. Moreover, the determined functional references are registered as skills by associating each skill with a description defining inputs, outputs, and functionality, and assigning the skills to the one or more AI agents using the Gen AI model. Also, the one or more AI agents are executed based on the selected appropriate agent configuration. In an aspect, the process of execution may include creating agent instances with defined runtime scopes and memory allocations, assigning the Gen AI model with associated configuration parameters along with model-specific configuration parameters (e.g., temperature, maximum tokens or prompt schema), and applying operational instructions, conversation constraints, (e.g., authorized access policies, data boundaries, and instruction limits), and authorized resources.

In addition, the resource engine 210 may determine a plurality of resources required for performing the task based on the determined AI agents and the plurality of operations required for performing the task. In an aspect, the plurality of resources may include operational resources ((e.g., service credentials, configuration profiles and the like), network resources (e.g., data transfer channels or latency thresholds), computational resources (e.g., Central Processing Units (CPUs), Graphical Processing Units (GPUs), memories and the like), and data storage resources (e.g., temporary caches, persistent databases or file systems). In an example implementation, the plurality of resources required for performing the one or more tasks are identified by evaluating configuration of the one or more AI agents and the plurality of operations based on agent capabilities, operational requirements, dependencies (e.g., tools, models or external systems) specified in the task context and the metadata and inference bindings (e.g., APIs, protocols, or middleware integrations).

Further, the metadata defining interface requirements, input-output specifications, operational dependencies and run-time constraints is accessed for performing the one or more tasks based on the identified plurality of resources. For example, the interface specifications details input-output data formats, content schemas, protocol requirements, and message validation constraints. The operational dependencies may include details of third-party services, authorization mechanisms, external APIs, or pre-trained model dependencies. The runtime constraints may include timeout settings, priority levels, and execution deadlines. Furthermore, the operational resources for performing the one or more tasks are identified based on the accessed metadata. For example, the operational resources may include service endpoints, credentials, configuration parameters, and policy constraints. In addition, the network resources for performing the one or more tasks are determined based on the accessed metadata. Example network resources may include connectivity endpoints and performance requirements.

Moreover, the computational resources for performing the one or more tasks are determined based on the accessed metadata. For example, the computational resources may include processing units, memory allocations, and model-specific requirements. Also, the data storage resources for performing the one or more tasks are determined based on the accessed metadata, wherein the data storage resources comprise temporary and persistent storage systems. Further, compatibility, and availability of the plurality of resources are validated based on compliance with system constraints using the AI model. In an aspect, compliance with system-level constraints, such as execution quotas, concurrency limits, or user permissions is checked. The AI model or rule-based system is then utilized to predict resource sufficiency or suggest optimizations based on task patterns and resource availability is then validated in real-time through infrastructure monitoring APIs. A resource allocation plan is then generated based on the determined one or more AI agents and the plurality of operations. Inn aspect, the resource allocation plan may be structured to include resource assignments mapped to each AI agent and the corresponding operations. Example resource allocation plan may include the operational resources, the network resources, the computational resources, and the data storage resources assigned to the one or more AI agents.

Moreover, the resource engine 210 may identify a Gen AI model and configuration parameters for the determined AI agents based on the determined plurality of resources. For example, the configuration parameters may include a model family, a context window, a temperature value, and safety settings. Thus, ensuring that the Gen AI model is compatible with the AI agent's functional requirements as well as the available computational, operational, and data resources. In an example implementation, compatible Gen AI model families are identified by evaluating the plurality of resources and the configuration parameters of the one or more AI agents based on model requirements. In an aspect, the evaluation may use a compatibility scoring algorithm, which compares the model metadata (including resource demands) against the system's resource availability and operational policies. The resource engine 210 may retrieve the information from the model database 222, a local or cloud-based service catalog that indexes multiple Gen AI models and associated specifications.

Further, a Gen AI model family is selected from the identified Gen AI model families based on compatibility with resource constraints (e.g., available memory, CPU or GPU cycles, and bandwidth), task requirements including expected output length, real-time processing needs, and task domain, and metadata constraints, such as data privacy requirements, regulatory mandates, or domain-specific limitations. Furthermore, a context window is determined for the selected Gen AI model family by estimating token requirements for task inputs (e.g., the user input), intermediate data (e.g., previous turns in a multi-turn conversation), and outputs (e.g., summaries, explanations, or completions), and selecting a context window aligning with the capabilities of the Gen AI model and available resources. In an aspect, the context window is selected from options supported by the chosen Gen AI model family, ensuring that the context window meets minimum task requirements while adhering to the resource availability (e.g., the memory and processing limits).

Moreover, a temperature value and sampling parameters for the selected Gen AI model family are determined based on the task type and the metadata constraints. In an aspect, tasks requiring deterministic outputs (e.g., classification or extraction) may use a lower temperature. For example, the sampling parameters may be adapted to control randomness and ensure response quality. In addition, the safety parameters for the selected Gen AI model family are determined by applying content filters that screen toxic, biased, or harmful outputs and/or policy enforcement rules, enforcing policy constraints specified in the task metadata (e.g., no generation of PII or misleading information) and usage limits consistent with the metadata constraints, such as output length limits or prompt guardrails to prevent misuse or model overreach. Also, the selected Gen AI model family, the context window, the temperature value, and the safety parameters are assigned to the one or more AI agents for task execution.

Also, the sequence determination module 212 may determine an execution sequence for performing the one or more tasks based on the identified Gen AI model and the configuration parameters. In an example implementation, candidate execution strategies are identified by evaluating the identified Gen AI model, the configuration parameters, the task type, the metadata, the plurality of operations, and available resources. For example, the candidate execution strategies may include single-agent execution models where one AI agent performs the full task in a linear or monolithic fashion and multi-agent execution models where tasks are divided into sub-tasks distributed across multiple specialized agents, possibly executing concurrently or in stages. Further, an execution strategy is selected from the identified candidate execution strategies based on compatibility with the identified Gen AI model, resource constraints, the task requirements, and the metadata constraints. Furthermore, an ordered sequence of executable steps is defined for the selected execution strategy. For example, the ordered sequence may include agent roles, model invocation parameters, authorized functions, memory access directives, and termination conditions for each step. In this example, the agent roles may specify which agent handles each step (e.g., planner, retriever, generator, or validator), the model invocation parameters may include prompt templates, temperature values, maximum token limits, and sampling parameters. The authorized functions may be functions or tools that an agent may invoke (e.g., search APIs, summarization modules, classification engines). The memory access directives may specify when and how agents access temporary or persistent memory stores. The termination conditions may define a criteria under which a step or the entire sequence completes (e.g., successful output, error trigger, and confidence threshold). Thus, each step is modeled with the metadata allows the system 104 to enforce constraints and handle branching or conditional execution paths.

In addition, resource consumption for the ordered sequence is estimated based on computational requirements (e.g., expected runtime, model loading time, and processing cycles), memory requirements factoring in context window usage, temporary data buffers, and cache allocations, and network requirements, such as data transmission volumes and expected bandwidth usage between steps. Moreover, concurrency protocols for the ordered sequence are established by identifying parallelizable steps especially in multi-agent workflows and defining execution priorities based on task dependencies. Also, invocation protocols for the authorized functions in each step are determined by defining execution modes (e.g., synchronous, asynchronous, or batched) and validation requirements for function calls, such as schema compliance, authentication tokens, response timeouts, and output verification. The protocols may integrate with an execution runtime environment that enforces guardrails and manages service calls.

Further, memory access operations for the ordered sequence are determined by defining data retrieval steps and storage steps across temporary systems (e.g., in-memory object caches, short-lived storage), and persistent systems (e.g., relational databases or distributed file systems). For example, the data retrieval steps may include fetching prior conversation context, loading external knowledge bases, or accessing temporary state objects. The data storage steps may include persisting final outputs, intermediate representations, or audit logs.

Furthermore, error handling protocols for the ordered sequence are defined by specifying recovery mechanisms and fallback strategies for execution failures. The recovery mechanisms may include retrying failed operations, fallback models, or alternate agent pathways. The fallback strategies includes using a simpler model, returning partial results, or escalating to a human-in-the-loop process. The error handling protocols may ensure execution resilience, especially in complex or mission-critical workflows. Moreover, the ordered sequence is validated based on the resource consumption, the concurrency protocols, the invocation protocols, the memory access operations, the error handling protocols, model constraints, the available resources, and system policies. The ordered sequence of executable steps is then generated as the execution sequence. In an aspect, the ordered sequence may integrate agent roles, function invocations, resource assignments, and memory operations to the Gen AI model. For example, the execution sequence is used to drive actual task performance and may be delivered as a machine-readable execution plan, a directed acyclic graph (DAG) for orchestration tools, and an internal scheduling queue for dynamic execution engines.

Further, the task execution engine 214 may execute the one or more tasks at the one or more AI agents based on the determined execution sequence, the identified Gen AI model, and the configuration parameters. In an example implementation, an execution environment is initialized for executing the one or more tasks based on the determined execution sequence, the identified Gen AI model, and the configuration parameters. In an aspect, the step of initializing may include activating the execution sequence, allocating specified resources, establishing a conversation state, and applying operational constraints. In some examples, the execution sequence is activated by parsing and registering the ordered sequence of steps, the agent roles, function bindings, and invocation constraints defined during the planning stage. The specified resources are then allocated by provisioning compute (e.g., CPU or GPU), memory, storage (temporary and persistent), and network bandwidth as determined by the resource engine 210. The conversation state is established by creating a shared memory structure to store context, prior messages, user intents, and generated outputs when the task involves dialog or multi-turn interaction. The operational constraints are applied by loading task-specific and system-wide policies (e.g., latency bounds, token limits, privacy rules) and enforcing by runtime guards or middleware. The initialization process may occur within a containerized, serverless, or managed runtime environment, supporting distributed and parallelized execution.

Further, the execution sequence of the executable steps is executed within the initialized execution environment. For example, each step may include generating one or more of a model invocation request with specified parameters, a conversation context, authorized functions, and intermediate data, retrieving data from memory systems, integrating the retrieved data into the model invocation request. In an aspect, the model invocation request is formulated based on parameters, such as temperature, top-k or top-p sampling, or maximum tokens, task-specific prompts, few-shot examples, or structured queries, and any applicable conversation context and historical data. The data may be retrieved by accessing external knowledge, memory stores, or context repositories using identifiers or queries derived from the task or prior steps. The retrieved data is then integrated into the model invocation request. The data integration may include embedding structured data into prompt templates, merging previous outputs or intermediate results, and conditioning inputs using memory snapshots or retrieval-augmented generation.

Furthermore, the Gen AI model is invoked for processing responses, and capturing performance metrics, executing authorized functions either as model-integrated tools (e.g., function calling APIs) or external service calls, validating inputs and outputs, and integrating results into the conversation state, and applying post-processing operations. In some examples, the inputs and outputs are validated by type checking, output schema validation, custom validators for task accuracy or content safety and the like. The results integrated into the conversation state may include model responses, function outputs, user context, dialog flow, or task progress indicators. The post-processing operations may include formatting, trimming, or anonymizing the output, converting structured outputs to API-compatible formats, triggering follow-up steps or preparing for agent transitions and the like.

Multi-agent interactions are then coordinated by managing agent communications and maintaining consistent conversation state during execution of the executable steps. The agent communications are managed by message passing between agents through internal communication protocols, publishing and subscribing to shared context changes or signals, escalating tasks from sub-agents to parent agents or coordinating tasks between peers and the like. Further, maintaining the consistent conversation state may ensure that the agents operate on a synchronized context that includes shared memory, task variables, execution history, user inputs and model outputs. Also, a final result is generated based on results of execution of the steps and coordinated multi-agent interactions by compiling an output, a conversation history, and execution metadata. In some examples, the compiled output may include a summary, answer, decision, classification result, or generated text. The conversation history may include a full interaction transcript, prompt-response pairs, and function invocation logs. The execution metadata may include as model usage statistics, resource consumption summaries, success/failure flags, and timestamps.

Furthermore, the response generation module 216 may include generating a response to the user input based on results of execution of the one or more tasks at the one or more AI agents. For example, the response may include one or more of a formatted answer, a processed dataset, an actionable output, and a report. In an aspect, the response may align with the task type and user requirements. Also, the output module 226 may include outputting the generated response on a user interface of a user device (e.g., the user device 108).

In an example implementation, the results of execution are aggregated by collecting intermediate artifacts, LLM responses, skill outputs, memory retrievals, and execution metadata generated during the ordered sequence of executable steps. Further, a response type and an output template are selected by mapping the at least one task type and explicit user requirements to a plurality of output targets. For example, the plurality of output targets ay include a human-readable formatted answer, a structured processed dataset, a machine-actionable payload, and a multi-section report. Furthermore, an output content including one or more of the human-readable formatted answer, the structured processed dataset, the machine-actionable payload, and the multi-section report is generated based on the selected response type and the output template. In addition, provenance data is embedded with the generated output content. Example provenance data may include source identifiers, retrieval timestamps, skill identifiers, and confidence scores.

Moreover, the generated content is validated based on policy constraints, safety constraints, and sensitivity constraints by applying content-moderation filters, and masking rules for sensitive data, policy-based transformation rules, and provider-specific safety parameters. Also, the generated content is re-validated with user-specified and system-imposed requirements by performing format validation check, completeness checks, and consistency checks with declared schema and data-typing rules. Further, a remediation action for the generated content is determined based on results of validation. For example, the remediation action may include attempting automated repair using predefined repair strategies, returning a diagnostic indicating a validation failure and recommending remediation steps. Post-processing operations is then performed on the generated content based on the determined remediation action. In an aspect, the post-processing operations may include one or more of rendering the generated content into user-requested output formats, generating and embedding visualizations by invoking visualization skills, and applying encryption to the generated content. Also, a final response is generated to the user input based on the performed post-processing operations. The final response may include one or more of a response payload in serialized formats, metadata, a bound Gen AI model family, a provider endpoint, a per-step and a cumulative token usage, timestamps, provenance data, identifiers for persisted intermediate artifacts and memory entries, and flags indicating applied policy transformations and validation status.

In an example implementation, the response generation module 216 is configured to generate a response to the user input based on the results produced by the execution of one or more tasks performed at the one or more AI agents. The response is formulated in accordance with the task type, the execution results, and user-specific or system-imposed requirements. The response generation module 216 initiates the response generation process by aggregating the various outputs and artifacts generated during task execution. The various outputs and artifacts may include intermediate artifacts produced during individual task steps, responses generated by the underlying Gen AI models or LLM responses, outputs from invoked skills (i.e., skill output) or external functions, memory retrievals from temporary or persistent data stores, and execution metadata, such as timestamps, function identifiers, and model usage statistics. The aggregation process may ensures that all relevant data, whether structured or unstructured, is available for response construction.

Once the relevant results are aggregated, the response generation module 216 may proceed to determine an appropriate response type and corresponding output template. The determination is performed by mapping the identified task type and any explicit user requirements to a predefined set of output targets. The output targets may include human-readable formatted answers (e.g., paragraphs, bullet points, or summaries), structured datasets (e.g., tables or payloads), machine-actionable outputs (e.g., serialized instructions or API-ready payloads), and multi-section reports that combine textual and visual content. Based on the mapping, a suitable output template is selected, defining the structure and formatting rules for presenting the final response.

Using the selected output type and template, the response generation module 216 may generate the initial output content. The output content may include one or more of a natural language explanation, a processed dataset, an executable payload, or a formatted report. During the generation process, the response generation module 216 may embed provenance metadata within the content. Such provenance information may include source identifiers (e.g., documents, knowledge bases, APIs), retrieval timestamps, skill or function identifiers, and confidence scores associated with the data or AI-generated outputs. The inclusion of provenance data may ensure traceability and accountability, that is particularly useful in regulated environments or systems requiring audit capabilities.

Upon the content generation, the response undergoes validation to ensure compliance with applicable constraints. In an aspect, policy-based validation is applied, which may include filters to enforce organizational rules, domain-specific content policies, and general safety guidelines. Further, safety constraints are enforced through the use of content moderation filters, toxicity classifiers, prompt-injection detection mechanisms, and other safeguards to prevent inappropriate or harmful content. Sensitivity constraints are also evaluated, and any detected personally identifiable or confidential information may be masked or transformed in accordance with predefined masking rules and security policies.

Once initial validations are completed, the response generation module 216 may perform further checks to validate the output against both user-specified and system-imposed structural and semantic requirements. The validation may include schema validation (e.g., format validation), completeness checks (ensuring all required fields are present), and consistency checks (e.g., verifying data types and alignment with expected value ranges or business rules). If any validation step fails, the response generation module 216 may identify an appropriate remediation action. Remediation actions may include automated repairs such as reformatting, regenerating specific parts of the output using alternative prompt strategies or functions, or returning a diagnostic output that explains the failure and recommends corrective action. In some examples, fallback mechanisms may invoke secondary models or tools to repair or replace invalid output segments.

Upon successful validation or remediation, the response generation module 216 may perform post-processing operations on the generated content. The operations may include rendering the output into the requested format (such as plain text, structured API payloads and the like), invoking visualization skills to embed charts, graphs, or tables within the output, and applying encryption or digital signatures to secure the content. The transformations may ensure that the final response is properly formatted, user-aligned, and compliant with access and transmission policies. The response generation module 216 may then generate and deliver the final response to the user device. The final response may include the primary content payload, along with supplemental metadata, such as timestamps, the identity of the Gen AI model family used, the endpoint that processed the request, token usage statistics (both per step and cumulative), identifiers for any persisted intermediate artifacts or memory entries, and flags indicating whether any policy transformations or safety filters were applied. The comprehensive packaging of response content and metadata may ensure that the output is transparent, traceable, and ready for further processing, presentation, or storage as required by the application context.

In some examples, the fine-tuning module 228 is configured to evaluate performance of the one or more AI agents based on the results obtained from execution of assigned tasks. The performance evaluation is carried out using a predefined set of criteria that is designed to capture both quantitative and qualitative aspects of task execution. The criteria may include execution speed, output accuracy, resource utilization, error rate and the like. The execution speed may be measured by calculating a time taken to complete a task or a specific step in the execution sequence. The accuracy may be determined by comparing the output of the AI agent against known ground truth data, user feedback, or expected outputs defined by validation rules. Resource utilization may be measured in terms of CPU usage, memory consumption, token counts, or API call volume, while error rate may include failure to invoke required functions, invalid output formats, or rejection during validation checks.

To conduct the evaluation, the fine-tuning module 228 may monitor runtime execution logs, collects telemetry data from the task execution engine, and retrieves performance metadata from the response generation module. The inputs are aggregated and analyzed using statistical models, heuristic thresholds, or learned performance baselines. In some implementations, the fine-tuning module 228 may incorporate a scoring mechanism or weighted evaluation function to produce a composite performance score for each agent or agent configuration. This score may be stored in a performance log or used to trigger downstream adaptation processes.

Based on the performance assessment, the fine-tuning module 228 may proceed to update the configuration of the one or more AI agents to improve future task performance. The configuration update may involve adjusting one or more elements, such as the Gen AI model parameters, the execution sequence, or the assigned system resources. For example, if an AI agent consistently exhibits high latency or fails to complete within acceptable thresholds, the system may reduce the context window or adjust temperature and sampling parameters to improve speed and predictability. If accuracy is found to be lacking, the fine-tuning module 228 may replace the underlying model family with a more suitable one, fine-tune prompt templates, or reconfigure the execution sequence to introduce additional validation or reasoning steps. If resource utilization is exceeding constraints, the fine-tuning module 228 may downgrade computational resources (e.g., allocate fewer GPUs), reduce memory allocations, or reassign tasks to more efficient agents. Conversely, if tasks are consistently failing due to resource insufficiency, the module may scale up resource provisioning or reroute execution to a high-capacity environment. The fine-tuning module 228 may also fine-tune the execution sequence by reordering steps, removing redundant operations, or parallelizing steps previously executed serially. All configuration updates are validated against system constraints and recorded for auditability.

In some examples, the fine-tuning module 228 may incorporate a feedback loop by storing performance metrics in the agent repository 230 and using machine learning techniques to predict optimal configurations for new tasks. This may include reinforcement learning approaches where agents are rewarded based on task efficiency and output quality. Over time, such self-optimization capabilities enable the AI agent system to adapt dynamically to new task types, user preferences, and environmental changes, thereby improving both performance and reliability in real-world scenarios.

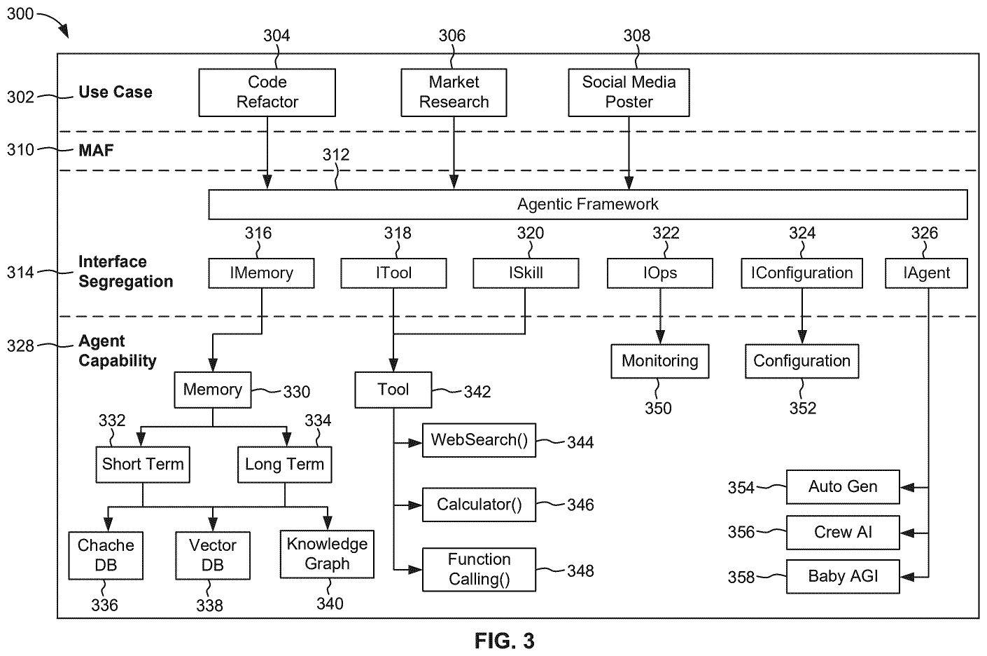

FIG. 3 depicts an example architecture of an Artificial Intelligence (AI)-based multi-agent abstraction framework 300, in accordance with implementations of the present disclosure. Particularly, the framework 300 enables diverse AI-driven use cases via a layered and extensible platform for intelligent agent execution, tool integration, memory management, observability, and configuration. The framework 300 may depict full stack, from high-level use cases to low-level agent capabilities, implemented using interface-driven modular components that allow for declarative configuration, runtime flexibility, and cross-domain reuse.

In an aspect, the framework 300 includes a set of representative use cases 302, which include a code refactor 304, market research 306, and social media poster 308. Each use case invokes or is routed to a shared Modular Agentic Framework (MAF) 310, represented by a shared agentic service layer (312) capable of adapting behavior through configuration and reusable logic blocks. Use cases interact with the shared agentic layer through structured inputs and task descriptions that are bound to skills, tools, and memory dynamically. Beneath the use case layer 302 is an interface segregation layer 314, which implements a clean separation of concerns through standardized interfaces, enabling plug-and-play extensibility. The interfaces include IMemory 316 for managing memory stores, such as short-term and long-term data, ITool 318 for exposing tools the agents may invoke (e.g., web search, calculators), ISkill 320 for higher-level functional behaviors or language model-wrapped functions, IOperations (IOps) 322 for capturing observability data including metrics and traces, IConfiguration 324 for resolving runtime configurations, including model types and policies, IAgent 326 for handling the lifecycle and execution logic of agents. Each of the interfaces may define an abstraction contract that enables the MAF 310 to operate with heterogeneous implementations without changing core logic. This modular design supports both proprietary and third-party plugins, simplifies testing, and allows feature injection or customization at runtime.

Further, an agent capability layer 328 illustrates the underlying operational modules that implement the logic exposed by the interfaces. For the IMemory 316, a memory module 330 supports both short term memory 332 with limited time or session scope, typically backed by a cache database 336 and long term persistent memory 334 using either vector databases 338 (e.g., the database 220) for semantic search or knowledge graphs 340 for structured relational storage. The memory backends are used during execution to store and retrieve facts, prior conversations, embeddings, or world knowledge, and may be queried directly by the agent or by invoked tools and skills. For the ITool 318, the framework 300 exposes a tool module 342 capable of handling externally callable utilities, such as Web Search( ) 344 for retrieving internet or enterprise data, calculator( ) 346 for performing mathematical operations, Function Calling( ) 348 for dynamically invoking language model-based function calls, which may be specified using schema and parsed responses. The tools may be configured declaratively and executed in a sandboxed or authenticated environment, with audit logging via the IOps pipeline. For the IOps 322, a monitoring module 350 is responsible for capturing telemetry, operational health, trace logs, and policy violations. The monitoring module 350 may integrate with external observability platforms. This enables real-time alerting, analytics, and compliance monitoring of agent behavior.

Further, for the IConfiguration 324, a configuration module 352 resolves critical runtime variables including model type, context length, temperature, rate limits, routing policies, agent limits, environment variables, and tool bindings. These configurations may be stored in environment-specific configuration managers and are injected into agent sessions dynamically. For the IAgent 326, the framework integrates a range of pluggable agent orchestrators that encapsulate decision-making, coordination, and conversational state management. For example, an Auto Gen 354 is a framework for multi-agent interaction with conversational turn-taking, a Crew AI 356 is a project-style orchestrator where agents collaborate on subtasks, a Baby AGI 358 is an autonomous agent loop with task prioritization and memory feedback. These agent orchestrators rely on the interface segregation model for modularity and may share tools, skills, memory, and configurations within a given session. The MAF 310 allows agents to be composed, swapped, or extended without altering the upstream use case logic. The entire framework 300 is designed to support declarative and configuration-first development, allowing developers or operators to compose agentic solutions by simply modifying configuration files rather than changing source code. The framework 300 drastically reduces coupling and accelerates reuse across domains.

In some examples, to enable the framework 300, each interface 314 must be implemented according to a contract specification, typically a base class or protocol definition in code language. Then agents are instantiated through a factory pattern using the IAgent interface 326, which loads agents from configuration and binds them to tools, skills, and memory. Further, the tools 342 are callable units (e.g., functions or APIs) exposed to agents via wrappers that conform to the ITool interface 318. The memory modules 330 interact with databases using standard APIs and the IMemory interface 316 abstracts this access. All observability data is funneled through the IOps interface 322, which exposes metrics, error tracking, and telemetry to pre-configured destinations. Also, configuration files are loaded at runtime via the IConfiguration provider or interface 324, allowing dynamic switching of models, tools, memory, and agent behavior.

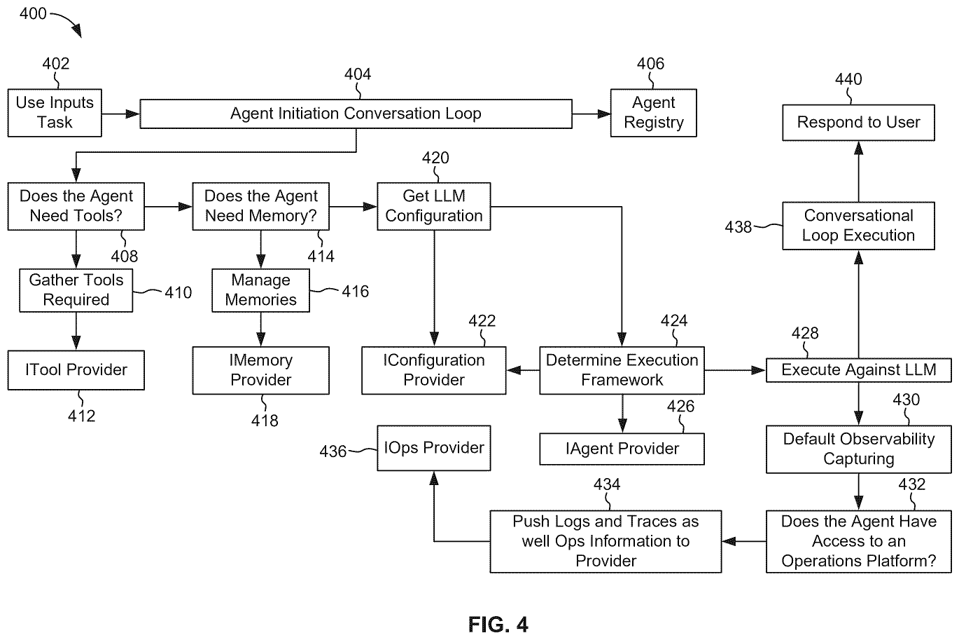

FIG. 4 depicts an example method 400 for context-aware task execution and adaptive response generation using the AI-based multi-agent abstraction framework 300, in accordance with implementations of the present disclosure. In an example implementation, the method 400 may include receiving a task where a user provides a task input 402, which may be a question, data request, action command, or a multi-step workflow. The input 402 may also include metadata, such as policy constraints, sensitivity labels, or domain-specific routing cues. Upon receiving the task, a configuration file resolves environment, credentials, and execution guardrails. The initialization is informed by a declarative configuration input, including agent configuration (e.g., name, system message, tools), memory store definitions, operations (observability backends), and LLM model configuration (e.g., model type, endpoint, credentials). The configuration is parsed and managed via an IConfiguration Provider 422 (e.g., the IConfiguration 324) throughout the execution.

Further, the method 400 may include an agent initiation conversation loop 404, which is responsible for selecting and instantiating the appropriate agent(s) using an agent registry 406 (i.e., the agent repository 230) and possibly a catalog of reusable agent templates or orchestrated groups via an IAgent provider 426 (i.e., the IAgent 326). Agents are initialized with associated conversation state, speaker graph (if multi-agent), limits, and available skills. Variable substitution and skill resolution happen at this stage using utility methods such as resolve functions( ) and load function( ) from the underlying platform. Once the agent is instantiated, the method 400 may include evaluating whether the agent requires external tools to perform the task 408. If the agent requires external tools to perform the task, the method 400 may include gathering tools (i.e., the tools 342) required 410 by loading or authorizing tool implementations an ITool Provider 412 (i.e., the ITool 318). The tools may include utilities for web access, computation, or API interactions. Where necessary, tools are abstracted into ISkill 320 wrappers, enabling language model invocation and structured usage tracking.

Furthermore, the method 400 may include assessing if the agent requires memory 414. If memory is needed, manage memories 416 is invoked to bind the agent to one or more memory backends (short-term caches or long-term vector/graph stores) using an IMemory Provider 418 (i.e., the IMemory 316). The memory modules may be local or remote and support configurable lifecycle rules such as time-to-live (TTL), compaction, or session-scoped access. Subsequently, get LLM configuration 420 resolves the appropriate large language model and execution parameters via the IConfiguration Provider 422. The parameters may include the model family, context window, temperature, safety settings, and API credentials. The configuration step may also enforces policy constraints and session-specific overrides.

In addition, the method 400 may include determines an execution framework 424 by selecting an orchestration method suitable for the task, single-agent or multi-agent group chat. If the execution plan involves multi-agent dialogue, a speaker transition graph is loaded, and compatibility across skills, tools, memory, and models is validated. The orchestration is facilitated by the IAgent Provider 426, which binds the agents to the execution runtime. Upon determining the execution plan or framework, the method 400 may include executing against LLM 428. The conversation loop is initiated, and the speaking agent reasons, invokes registered skills (which wrap tools), accesses memory, and continues until termination criteria are met, either through completion, maximum turn limits, or explicit end signals. The method 400 may support intermediate result flows such as passage retrieval, graph traversal, or computation results. Execution is monitored and does not rely on specific model providers, allowing for model/backend substitutions without logic changes. As the execution proceeds, the method 400 may include activating default observability capturing technique 430. The technique logs all relevant performance and behavioral metrics, including tool/skill calls, token usage, latencies, errors, and health signals. Also, the method 400 may include checking if the agent has access to an operations platform 432. If affirmative, push logs and traces as well as operations information to provider 434 occurs, sending observability artifacts to the appropriate backend via an IOps provider 436 (i.e., the IOps 322). The logs are used for auditing, service level agreement monitoring, replay, and diagnostics. Once execution concludes 438, the method 400 may include finalizing the session and respond to a user 440 with the output. The response can include structured answers, transformed data, formatted results, or downstream actions (e.g., API callback, file drop). If configured, results and learnings are persisted in memory for future optimization.

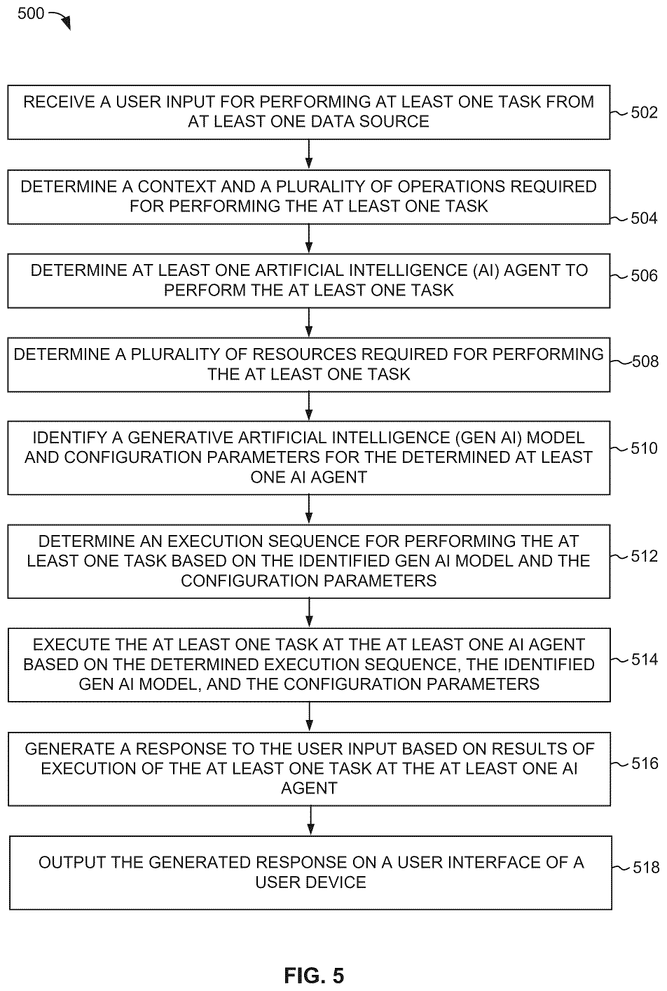

FIG. 5 is a flow diagram that represents an example processor-executable method 500 for context-aware task execution and adaptive response generation using AI agents, in accordance with implementations of the present disclosure. In some implementations, the method 500 may be executed by the processor 202 (including the one or more processors), as described in relation to FIGS. 2-4.

In an example implementation, the method 500 may include receiving a user input 502 for performing one or more tasks from one or more data sources (i.e., the plurality of data sources 102A-N. For example, the user input may include one or more of a question, a workflow request, and an action. Further, the method 500 may include determining a context and a plurality of operations 504 required for performing the one or more tasks based on a task type, and metadata associated with the task using an AI model. For example, the metadata may include domain information, policy information, and sensitivity information. In an example implementation, task constraints and task requirements corresponding to the one or more tasks are identified by extracting a plurality of features from the task type and the metadata. Further, in this example implementation, the task type is classified into a plurality of categories based on the identified task constraints and the task requirements. For example, the categories may include a question resolution, a workflow orchestration, and an action performance.

Furthermore, a task context for the one or more tasks is generated based on the classification. For example, the task context may include environmental constraints, compliance rules, and security protocols. In addition, the one or more tasks are mapped to the plurality of operations required for execution of the one or more tasks based on the generated task context. In an aspect, the process of mapping may include selecting the plurality of operations from a predefined set based on the task context. For example, the operations may include one or more of data retrieval from specified sources, computational processing, and accessing memory.

Furthermore, the method 500 may include determining one or more AI agents 506 to perform the task based on the determined context, the task type, the metadata associated with the task and the plurality of operations required for performing the task. In an example implementation, candidate agent configurations are identified from an agent repository (e.g., the agent repository) 230 by matching the configuration parameters to the task context, the task type, the metadata, and the plurality of operations. For example, the configuration parameters may include agent capabilities and operational constraints. Further, in the example implementation, the identified candidate agent configurations are ranked based on compatibility with the task context, metadata constraints, and alignment with the plurality of operations and available system resources. Furthermore, an appropriate agent configuration is selected for performing the one or more tasks based on the ranked candidate agent configurations.

In addition, functional references are determined in the selected appropriate agent configuration. The functional references may include executable functions from specified sources to support task-specific operations. Moreover, the determined functional references are registered as skills by associating each skill with a description defining inputs, outputs, and functionality, and assigning the skills to the one or more AI agents using the Gen AI model. Also, the one or more AI agents are executed based on the selected appropriate agent configuration. In an aspect, the process of execution may include creating agent instances, assigning the Gen AI model with associated configuration parameters, and applying operational instructions, conversation constraints, and authorized resources.

In addition, the method 500 may include determining a plurality of resources 508 required for performing the task based on the determined AI agents and the plurality of operations required for performing the task. In an aspect, the plurality of resources may include operational resources, network resources, computational resources, and data storage resources. In an example implementation, the plurality of resources required for performing the one or more tasks are identified by evaluating configuration of the one or more AI agents and the plurality of operations based on agent capabilities, operational requirements, and dependencies specified in the task context and the metadata. Further, the metadata defining interface requirements, input-output specifications, and operational dependencies is accessed for performing the one or more tasks based on the identified plurality of resources. Furthermore, the operational resources for performing the one or more tasks are identified based on the accessed metadata. For example, the operational resources may include service endpoints, credentials, configuration parameters, and policy constraints. In addition, the network resources for performing the one or more tasks are determined based on the accessed metadata. Example network resources may include connectivity endpoints and performance requirements.

Moreover, the computational resources for performing the one or more tasks are determined based on the accessed metadata. For example, the computational resources may include processing units, memory allocations, and model-specific requirements. Also, the data storage resources for performing the one or more tasks are determined based on the accessed metadata, wherein the data storage resources comprise temporary and persistent storage systems. Further, compatibility, and availability of the plurality of resources are validated based on compliance with system constraints using the AI model. A resource allocation plan is then generated based on the determined one or more AI agents and the plurality of operations. Example resource allocation plan may include the operational resources, the network resources, the computational resources, and the data storage resources assigned to the one or more AI agents.

Moreover, the method 500 may include identifying a Gen AI model and configuration parameters 510 for the determined AI agents based on the determined plurality of resources. For example, the configuration parameters may include a model family, a context window, a temperature value, and safety settings. In an example implementation, compatible Gen AI model families are identified by evaluating the plurality of resources and the configuration parameters of the one or more AI agents based on model requirements. Further, a Gen AI model family is selected from the identified Gen AI model families based on compatibility with resource constraints, task requirements, and metadata constraints. Furthermore, a context window is determined for the selected Gen AI model family by estimating token requirements for task inputs, intermediate data, and outputs, and selecting a context window aligning with the capabilities of the Gen AI model and available resources. Moreover, a temperature value and sampling parameters for the selected Gen AI model family are determined based on the task type and the metadata constraints. In addition, the safety parameters for the selected Gen AI model family are determined by applying content filters, policy enforcement rules, and usage limits consistent with the metadata constraints. Also, the selected Gen AI model family, the context window, the temperature value, and the safety parameters are assigned to the one or more AI agents for task execution.

Also, the method 500 may include determining an execution sequence 512 for performing the one or more tasks based on the identified Gen AI model and the configuration parameters. In an example implementation, candidate execution strategies are identified by evaluating the identified Gen AI model, the configuration parameters, the task type, the metadata, the plurality of operations, and available resources. For example, the candidate execution strategies may include single-agent execution models and multi-agent execution models. Further, an execution strategy is selected from the identified candidate execution strategies based on compatibility with the identified Gen AI model, resource constraints, the task requirements, and the metadata constraints. Furthermore, an ordered sequence of executable steps is defined for the selected execution strategy. For example, the ordered sequence may include agent roles, model invocation parameters, authorized functions, memory access directives, and termination conditions for each step. In addition, resource consumption for the ordered sequence is estimated based on computational requirements (e.g., expected runtime, model loading time, and processing cycles), memory requirements factoring in context window usage, temporary data buffers, and cache allocations, and network requirements. Moreover, concurrency protocols for the ordered sequence are established by identifying parallelizable steps and defining execution priorities based on task dependencies. Also, invocation protocols for the authorized functions in each step are determined by defining execution modes and validation requirements for function calls.

Further, memory access operations for the ordered sequence are determined by defining data retrieval steps and storage steps across temporary systems and persistent systems. Furthermore, error handling protocols for the ordered sequence are defined by specifying recovery mechanisms and fallback strategies for execution failures. Moreover, the ordered sequence is validated based on the resource consumption, the concurrency protocols, the invocation protocols, the memory access operations, the error handling protocols, model constraints, the available resources, and system policies. The ordered sequence of executable steps is then generated as the execution sequence. In an aspect, the ordered sequence may integrate agent roles, function invocations, resource assignments, and memory operations to the Gen AI model.

Further, the method 500 may include executing the one or more tasks 514 at the one or more AI agents based on the determined execution sequence, the identified Gen AI model, and the configuration parameters. In an example implementation, an execution environment is initialized for executing the one or more tasks based on the determined execution sequence, the identified Gen AI model, and the configuration parameters. In an aspect, the step of initializing may include activating the execution sequence, allocating specified resources, establishing a conversation state, and applying operational constraints. Further, the execution sequence of the executable steps is executed within the initialized execution environment. For example, each step may include generating one or more of a model invocation request with specified parameters, a conversation context, authorized functions, and intermediate data, retrieving data from memory systems, integrating the retrieved data into the model invocation request. Furthermore, the Gen AI model is invoked for processing responses, and capturing performance metrics, executing authorized functions, validating inputs and outputs, and integrating results into the conversation state, and applying post-processing operations. Multi-agent interactions are then coordinated by managing agent communications and maintaining consistent conversation state during execution of the executable steps. Also, a final result is generated based on results of execution of the steps and coordinated multi-agent interactions by compiling an output, a conversation history, and execution metadata.

Furthermore, the method 500 may include generating a response 516 to the user input based on results of execution of the one or more tasks at the one or more AI agents. For example, the response may include one or more of a formatted answer, a processed dataset, an actionable output, a report. In an aspect, the response may align with the task type and user requirements. Also, the method 500 may include outputting the generated response 518 on a user interface of a user device (e.g., the user device 108).

In an example implementation, the results of execution are aggregated by collecting intermediate artifacts, LLM responses, skill outputs, memory retrievals, and execution metadata generated during the ordered sequence of executable steps. Further, a response type and an output template are selected by mapping the at least one task type and explicit user requirements to a plurality of output targets. For example, the plurality of output targets ay include a human-readable formatted answer, a structured processed dataset, a machine-actionable payload, and a multi-section report. Furthermore, an output content including one or more of the human-readable formatted answer, the structured processed dataset, the machine-actionable payload, and the multi-section report is generated based on the selected response type and the output template. In addition, provenance data is embedded with the generated output content. Example provenance data may include source identifiers, retrieval timestamps, skill identifiers, and confidence scores.

Moreover, the generated content is validated based on policy constraints, safety constraints, and sensitivity constraints by applying content-moderation filters, and masking rules for sensitive data, policy-based transformation rules, and provider-specific safety parameters. Also, the generated content is re-validated with user-specified and system-imposed requirements by performing format validation check, completeness checks, and consistency checks with declared schema and data-typing rules. Further, a remediation action for the generated content is determined based on results of validation. For example, the remediation action may include attempting automated repair using predefined repair strategies, returning a diagnostic indicating a validation failure and recommending remediation steps. Post-processing operations is then performed on the generated content based on the determined remediation action. In an aspect, the post-processing operations may include one or more of rendering the generated content into user-requested output formats, generating and embedding visualizations by invoking visualization skills, and applying encryption to the generated content. Also, a final response is generated to the user input based on the performed post-processing operations. The final response may include one or more of a response payload in serialized formats, metadata, a bound Gen AI model family, a provider endpoint, a per-step and a cumulative token usage, timestamps, provenance data, identifiers for persisted intermediate artifacts and memory entries, and flags indicating applied policy transformations and validation status.

In some examples, the method 500 may include determining a performance of the one or more AI agents based on results of execution using a set of predefined criteria. For example, the set of predefined criteria may include a speed, an accuracy, a resource utilization, and an error rate. Further, the method 500 may include updating a configuration of the one or more AI agents based on the determined performance. The configuration may include one or more of the configuration parameters of the Gen AI model, the execution sequence, and the plurality of resources.

Implementations of the present disclosure provide an intelligent task execution and response generation system that dynamically interprets diverse user inputs, such as questions, workflow requests, or commands, without requiring predefined formats or static logic. By leveraging AI to analyze contextual metadata (e.g., domain, policy, sensitivity), the system reduces manual configuration and supports a wide range of enterprise use cases with minimal engineering effort. The present disclosure is able to dynamically select and instantiate AI agents and allocate computational, memory, and network resources based on task complexity. The system also auto-configures LLM parameters (e.g., model family, temperature, safety) for optimized task-specific behavior.

Through structured agent orchestration and modular design, the system improves scalability, reliability, and output quality. The system also abstracts multi-agent frameworks under a unified interface, significantly reducing onboarding and integration time. Developers or users can easily incorporate external tools and APIs without concern for compatibility, fostering rapid development. Also, the system enables maintainability, observability, and secure extensibility. Real-time telemetry and auditability make the system suitable for regulated environments. The framework-agnostic and portable design ensures future-proof deployment across on-premise, cloud, and hybrid infrastructures, supporting scalable and adaptable AI-powered automation.

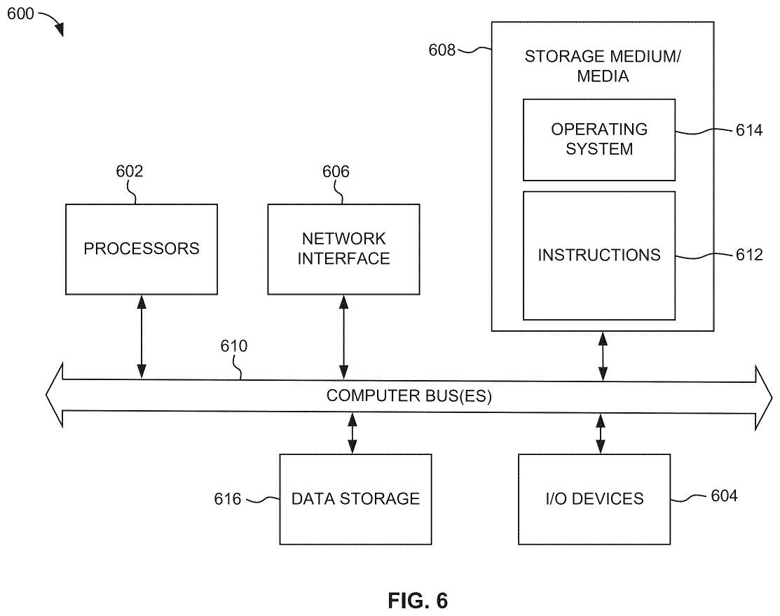

FIG. 6 illustrates a computer system 600 (i.e., the task execution and response generation system 104) that may be used to implement the method for context-aware task execution and adaptive response generation using AI agents, in accordance with the implementations of the present disclosure. More particularly, computing machines such as desktops, laptops, smartphones, tablets, and wearables which may be used to perform the software testing. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 602.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the system 104.

The system 600 may be implemented as software stored on a non-transitory processor-readable medium and executed by the processor(s) 602. For example, the computer-readable medium 608 may store an operating system 614, such as MAC OS, MS WINDOWS, UNIX, or LINUX, and code, for the system 600. The operating system 614 may be multi-user, multiprocessing, multitasking, multithreading, real-time, and the like. For example, during runtime, the operating system 614 is running and the code for the computer system 600 is executed by the processor(s) 602.

The computer system 600 may include a data storage 616, which may include non-volatile data storage. The data storage 616 stores any data used or generated by the system 104. The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, the system 104). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 602 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a user input for performing at least one task from at least one data source, wherein the user input comprises at least one of a question, a workflow request, and an action;
determine a context and a plurality of operations required for performing the at least one task based on a task type, and metadata associated with the at least one task using an Artificial Intelligence (AI) model, wherein the metadata comprises domain information, policy information, and sensitivity information;
determine at least one AI agent to perform the at least one task based on the determined context, the task type, the metadata associated with the at least one task and the plurality of operations required for performing the at least one task;
determine a plurality of resources required for performing the at least one task based on the determined at least one AI agent and the plurality of operations required for performing the at least one task, wherein the plurality of resources comprise operational resources, network resources, computational resources, and data storage resources;
identify a Generative Artificial Intelligence (Gen AI) model and configuration parameters for the determined at least one AI agent based on the determined plurality of resources, wherein the configuration parameters comprise a model family, a context window, a temperature value, and safety settings;
determine an execution sequence for performing the at least one task based on the identified Gen AI model and the configuration parameters;
execute the at least one task at the at least one AI agent based on the determined execution sequence, the identified Gen AI model, and the configuration parameters;
generate a response to the user input based on results of execution of the at least one task at the at least one AI agent, wherein the response comprises at least one of a formatted answer, a processed dataset, an actionable output, a report, and wherein the response aligns with the task type and user requirements; and
output the generated response on a user interface of a user device.

2. The system of claim 1, wherein the processor is to:
determine a performance of the at least one AI agent based on results of execution using a set of predefined criteria, wherein the set of predefined criteria comprises a speed, an accuracy, a resource utilization, and an error rate; and
update a configuration of the at least one AI agent based on the determined performance, wherein the configuration comprises at least one of the configuration parameters of the Gen AI model, the execution sequence, and the plurality of resources.

3. The system of claim 1, wherein to determine the context and the plurality of operations required for performing the at least one task based on the task type, and the metadata associated with the at least one task using the AI model, the processor is to:
identify task constraints and task requirements corresponding to the at least one task by extracting a plurality of features from the task type and the metadata;
classify the task type into a plurality of categories based on the identified task constraints and the task requirements, wherein the plurality of categories comprise a question resolution, a workflow orchestration, and an action performance;
generate a task context for the at least one task based on the classification, wherein the task context comprises environmental constraints, compliance rules, and security protocols; and
map the at least one task to the plurality of operations required for execution of the at least one task based on the generated task context, wherein the mapping comprises selecting the plurality of operations from a predefined set based on the task context, and wherein the plurality of operations comprise at least one of data retrieval from specified sources, computational processing, and accessing memory.

4. The system of claim 1, wherein to determine the at least one AI agent to perform the at least one task based on the determined context, the task type, the metadata associated with the at least one task and the plurality of operations required for performing the at least one task, the processor is to:
identify candidate agent configurations from an agent repository by matching the configuration parameters to the task context, the task type, the metadata, and the plurality of operations, wherein the configuration parameters comprise agent capabilities and operational constraints;
rank the identified candidate agent configurations based on compatibility with the task context, metadata constraints, and alignment with the plurality of operations and available system resources;
select an appropriate agent configuration for performing the at least one task based on the ranked candidate agent configurations;
determine functional references in the selected appropriate agent configuration, wherein the functional references comprise executable functions from specified sources to support task-specific operations;
register the determined functional references as skills by associating each skill with a description defining inputs, outputs, and functionality, and assigning the skills to the at least one AI agent using the Gen AI model; and
execute the at least one AI agent based on the selected appropriate agent configuration, wherein the execution comprises creating agent instances, assigning the Gen AI model with associated configuration parameters, and applying operational instructions, conversation constraints, and authorized resources.

5. The system of claim 1, wherein to determine the plurality of resources required for performing the at least one task based on the determined at least one AI agent and the plurality of operations required for performing the at least one task, the processor is to:
identify the plurality of resources required for performing the at least one task by evaluating configuration of the at least one AI agent and the plurality of operations based on agent capabilities, operational requirements, and dependencies specified in the task context and the metadata;
access the metadata defining interface requirements, input-output specifications, and operational dependencies for performing the at least one task based on the identified plurality of resources;
identify the operational resources for performing the at least one task based on the accessed metadata, wherein the operational resources comprise service endpoints, credentials, configuration parameters, and policy constraints;
determine the network resources for performing the at least one task based on the accessed metadata, wherein the network resources comprise connectivity endpoints and performance requirements;
determine the computational resources for performing the at least one task based on the accessed metadata, wherein the computational resources comprise processing units, memory allocations, and model-specific requirements;
determine the data storage resources for performing the at least one task based on the accessed metadata, wherein the data storage resources comprise temporary and persistent storage systems;
validate compatibility and availability of the plurality of resources based on compliance with system constraints using the AI model; and
generate a resource allocation plan based on the determined at least one AI agent and the plurality of operations required for performing the at least one task, wherein the resource allocation plan comprises the operational resources, the network resources, the computational resources, and the data storage resources assigned to the AI agent.

6. The system of claim 1, wherein to identify the Gen AI model and the configuration parameters for the determined at least one AI agent based on the determined plurality of resources, the processor is to:
identify compatible Gen AI model families by evaluating the plurality of resources and the configuration parameters of the at least one AI agent based on model requirements;
select a Gen AI model family from the identified Gen AI model families based on compatibility with resource constraints, task requirements, and metadata constraints;
determine a context window for the selected Gen AI model family by estimating token requirements for task inputs, intermediate data, and outputs, and selecting a context window aligning with the capabilities of the Gen AI model and available resources;
determine a temperature value and sampling parameters for the selected Gen AI model family based on the task type and the metadata constraints;
determine the safety parameters for the selected Gen AI model family by applying content filters, policy enforcement rules, and usage limits consistent with the metadata constraints; and
assign the selected Gen AI model family, the context window, the temperature value, and the safety parameters to the at least one AI agent for task execution.

7. The system of claim 1, wherein to determine the execution sequence for performing the at least one task based on the identified Gen AI model and the configuration parameters, the processor is to:
identify candidate execution strategies by evaluating the identified Gen AI model, the configuration parameters, the task type, the metadata, the plurality of operations, and available resources, wherein the candidate execution strategies comprise single-agent execution models and multi-agent execution models;
select an execution strategy from the identified candidate execution strategies based on compatibility with the identified Gen AI model, resource constraints, the task requirements, and the metadata constraints;
define an ordered sequence of executable steps for the selected execution strategy, wherein the ordered sequence comprises agent roles, model invocation parameters, authorized functions, memory access directives, and termination conditions for each step;
estimate resource consumption for the ordered sequence based on computational requirements, memory requirements, and the network requirements;
establish concurrency protocols for the ordered sequence by identifying parallelizable steps and defining execution priorities based on task dependencies;
determine invocation protocols for the authorized functions in each step by defining execution modes and validation requirements for function calls;
determine memory access operations for the ordered sequence by defining data retrieval steps and storage steps across temporary systems and persistent systems;
define error handling protocols for the ordered sequence by specifying recovery mechanisms and fallback strategies for execution failures;
validate the ordered sequence based on the resource consumption, the concurrency protocols, the invocation protocols, the memory access operations, the error handling protocols, model constraints, the available resources, and system policies; and
generate the ordered sequence of executable steps as the execution sequence, wherein the ordered sequence integrates agent roles, function invocations, resource assignments, and memory operations to the Gen AI model.

8. The system of claim 1, wherein to execute the at least one task at the at least one AI agent based on the determined execution sequence, the identified Gen AI model and the configuration parameters, the processor is to:
initialize an execution environment for executing the at least one task based on the determined execution sequence, the identified Gen AI model, and the configuration parameters, wherein the initializing comprises activating the execution sequence, allocating specified resources, establishing a conversation state, and applying operational constraints;
execute the execution sequence of executable steps within the initialized execution environment, wherein each step comprises generating at least one of a model invocation request with specified parameters, a conversation context, authorized functions, and intermediate data, retrieving data from memory systems, integrating the retrieved data into the model invocation request;
invoking the Gen AI model for processing responses, and capturing performance metrics, executing authorized functions, validating inputs and outputs, and integrating results into the conversation state, and applying post-processing operations;
coordinate multi-agent interactions by managing agent communications and maintaining consistent conversation state during execution of the executable steps; and
generate a final result based on results of execution of the steps and coordinated multi-agent interactions by compiling an output, a conversation history, and execution metadata.

9. The system of claim 1, wherein to generate the response to the user input based on the results of execution of the at least one task at the at least one AI agent, the processor is to:
aggregate the results of execution by collecting intermediate artifacts, Large Language Model (LLM) responses, skill outputs, memory retrievals, and execution metadata generated during the ordered sequence of executable steps;
select a response type and an output template by mapping the task type and explicit user requirements to a plurality of output targets, wherein the plurality of output targets comprise a human-readable formatted answer, a structured processed dataset, a machine-actionable payload, and a multi-section report;
generate an output content comprising at least one of the human-readable formatted answer, the structured processed dataset, the machine-actionable payload, and the multi-section report based on the selected response type and the output template;
embed provenance data with the generated output content, wherein the provenance data comprises source identifiers, retrieval timestamps, skill identifiers, and confidence scores;
validate the generated content based on policy constraints, safety constraints, and sensitivity constraints by applying content-moderation filters and masking rules for sensitive data, policy-based transformation rules, and provider-specific safety parameters;
re-validate the generated content with user-specified and system-imposed requirements by performing format validation check, completeness checks, and consistency checks with declared schema and data-typing rules;
determine a remediation action for the generated content based on results of validation, wherein the remediation action comprises attempting automated repair using predefined repair strategies, returning a diagnostic indicating a validation failure and recommending remediation steps;
perform post-processing operations on the generated content based on the determined remediation action, wherein the post-processing operations comprise at least one of rendering the generated content into user-requested output formats, generating and embedding visualizations by invoking visualization skills, and applying encryption to the generated content; and
generate a final response to the user input based on the performed post-processing operations, wherein the final response comprises at least one of a response payload in serialized formats, metadata, a bound Gen AI model family, a provider endpoint, a per-step and a cumulative token usage, timestamps, provenance data, identifiers for persisted intermediate artifacts and memory entries, and flags indicating applied policy transformations and validation status.

10. A method comprising:
receiving, by a processor, a user input for performing at least one task from at least one data source, wherein the user input comprises at least one of a question, a workflow request, and an action;
determining, by the processor, a context and a plurality of operations required for performing the at least one task based on a task type, and metadata associated with the at least one task using an Artificial Intelligence (AI) model, wherein the metadata comprises domain information, policy information, and sensitivity information;
determining, by the processor, at least one AI agent to perform the at least one task based on the determined context, the task type, the metadata associated with the at least one task and the plurality of operations required for performing the at least one task;
determining, by the processor, a plurality of resources required for performing the at least one task based on the determined at least one AI agent and the plurality of operations required for performing the at least one task, wherein the plurality of resources comprise operational resources, network resources, computational resources, and data storage resources;
identifying, by the processor, a Generative Artificial Intelligence (Gen AI) model and configuration parameters for the determined at least one AI agent based on the determined plurality of resources, wherein the configuration parameters comprise a model family, a context window, a temperature value, and safety settings;
determining, by the processor, an execution sequence for performing the at least one task based on the identified Gen AI model and the configuration parameters;
executing, by the processor, the at least one task at the at least one AI agent based on the determined execution sequence, the identified Gen AI model, and the configuration parameters;
generating, by the processor, a response to the user input based on results of execution of the at least one task at the at least one AI agent, wherein the response comprises at least one of a formatted answer, a processed dataset, an actionable output, a report, and wherein the response aligns with the task type and user requirements; and
outputting, by the processor, the generated response on a user interface of a user device.

11. The method of claim 10, further comprising:
determining, by the processor, a performance of the at least one AI agent based on results of execution using a set of predefined criteria, wherein the set of predefined criteria comprises a speed, an accuracy, a resource utilization, and an error rate; and
updating, by the processor, a configuration of the at least one AI agent based on the determined performance, wherein the configuration comprises at least one of the configuration parameters of the Gen AI model, the execution sequence, and the plurality of resources.

12. The method of claim 10, wherein determining the context and the plurality of operations required for performing the at least one task based on the task type, and the metadata associated with the at least one task using the AI model comprises:
identifying, by the processor, task constraints and task requirements corresponding to the at least one task by extracting a plurality of features from the task type and the metadata;
classifying, by the processor, the task type into a plurality of categories based on the identified task constraints and the task requirements, wherein the plurality of categories comprise a question resolution, a workflow orchestration, and an action performance;
generating, by the processor, a task context for the at least one task based on the classification, wherein the task context comprises environmental constraints, compliance rules, and security protocols; and
mapping, by the processor, the at least one task to the plurality of operations required for execution of the at least one task based on the generated task context, wherein the mapping comprises selecting the plurality of operations from a predefined set based on the task context, and wherein the plurality of operations comprise at least one of data retrieval from specified sources, computational processing, and accessing memory.

13. The method of claim 10, wherein determining the at least one AI agent to perform the task based on the determined context, the task type, the metadata associated with the at least one task and the plurality of operations required for performing the at least one task comprises:
identifying, by the processor, candidate agent configurations from an agent repository by matching the configuration parameters to the task context, the task type, the metadata, and the plurality of operations, wherein the configuration parameters comprise agent capabilities and operational constraints;
ranking, by the processor, the identified candidate agent configurations based on compatibility with the task context, metadata constraints, and alignment with the plurality of operations and available system resources;
selecting, by the processor, an appropriate agent configuration for performing the at least one task based on the ranked candidate agent configurations;
determining, by the processor, functional references in the selected appropriate agent configuration, wherein the functional references comprise executable functions from specified sources to support task-specific operations;
registering, by the processor, the determined functional references as skills by associating each skill with a description defining inputs, outputs, and functionality, and assigning the skills to the at least one AI agent using the Gen AI model; and
executing, by the processor, the at least one AI agent based on the selected appropriate agent configuration, wherein the execution comprises creating agent instances, assigning the Gen AI model with associated configuration parameters, and applying operational instructions, conversation constraints, and authorized resources.

14. The method of claim 10, wherein determining the plurality of resources required for performing the at least one task based on the determined at least one AI agent and the plurality of operations required for performing the at least one task comprises:
identifying, by the processor, the plurality of resources required for performing the at least one task by evaluating configuration of the at least one AI agent and the plurality of operations based on agent capabilities, operational requirements, and dependencies specified in the task context and the metadata;
accessing, by the processor, the metadata defining interface requirements, input-output specifications, and operational dependencies for performing the at least one task based on the identified plurality of resources;
identifying, by the processor, the operational resources for performing the at least one task based on the accessed metadata, wherein the operational resources comprise service endpoints, credentials, configuration parameters, and policy constraints;
determining, by the processor, the network resources for performing the at least one task based on the accessed metadata, wherein the network resources comprise connectivity endpoints and performance requirements;
determining, by the processor, the computational resources for performing the at least one task based on the accessed metadata, wherein the computational resources comprise processing units, memory allocations, and model-specific requirements;
determining, by the processor, the data storage resources for performing the at least one task based on the accessed metadata, wherein the data storage resources comprise temporary and persistent storage systems;
validating, by the processor, compatibility, and availability of the plurality of resources based on compliance with system constraints using the AI model; and
generating, by the processor, a resource allocation plan based on the determined at least one AI agent and the plurality of operations required for performing the at least one task, wherein the resource allocation plan comprises the operational resources, the network resources, the computational resources, and the data storage resources assigned to the AI agent.

15. The method of claim 10, wherein identifying the Gen AI model and the configuration parameters for the determined at least one AI agent based on the determined plurality of resources comprises:
identifying, by the processor, compatible Gen AI model families by evaluating the plurality of resources and the configuration parameters of the at least one AI agent based on model requirements;
selecting, by the processor, a Gen AI model family from the identified Gen AI model families based on compatibility with resource constraints, task requirements, and metadata constraints;
determining, by the processor, a context window for the selected Gen AI model family by estimating token requirements for task inputs, intermediate data, and outputs, and selecting a context window aligning with the capabilities of the Gen AI model and available resources;
determining, by the processor, a temperature value and sampling parameters for the selected Gen AI model family based on the task type and the metadata constraints;
determining, by the processor, the safety parameters for the selected Gen AI model family by applying content filters, policy enforcement rules, and usage limits consistent with the metadata constraints; and
assigning, by the processor, the selected Gen AI model family, the context window, the temperature value, and the safety parameters to the at least one AI agent for task execution.

16. The method of claim 10, wherein determining the execution sequence for performing the at least one task based on the identified Gen AI model and the configuration parameters comprises:
identifying, by the processor, candidate execution strategies by evaluating the identified Gen AI model, the configuration parameters, the task type, the metadata, the plurality of operations, and available resources, wherein the candidate execution strategies comprise single-agent execution models and multi-agent execution models;
selecting, by the processor, an execution strategy from the identified candidate execution strategies based on compatibility with the identified Gen AI model, resource constraints, the task requirements, and the metadata constraints;
defining, by the processor, an ordered sequence of executable steps for the selected execution strategy, wherein the ordered sequence comprises agent roles, model invocation parameters, authorized functions, memory access directives, and termination conditions for each step;
estimating, by the processor, resource consumption for the ordered sequence based on computational requirements, memory requirements, and network requirements;
establishing, by the processor, concurrency protocols for the ordered sequence by identifying parallelizable steps and defining execution priorities based on task dependencies;
determining, by the processor, invocation protocols for the authorized functions in each step by defining execution modes and validation requirements for function calls;
determining, by the processor, memory access operations for the ordered sequence by defining data retrieval steps and storage steps across temporary systems and persistent systems;
defining, by the processor, error handling protocols for the ordered sequence by specifying recovery mechanisms and fallback strategies for execution failures;
validating, by the processor, the ordered sequence based on the resource consumption, the concurrency protocols, the invocation protocols, the memory access operations, the error handling protocols, model constraints, the available resources, and system policies; and
generating, by the processor, the ordered sequence of executable steps as the execution sequence, wherein the ordered sequence integrates agent roles, function invocations, resource assignments, and memory operations to the Gen AI model.

17. The method of claim 10, wherein executing the at least one task at the at least one AI agent based on the determined execution sequence, the identified Gen AI model and the configuration parameters comprises:
initializing, by the processor, an execution environment for executing the at least one task based on the determined execution sequence, the identified Gen AI model, and the configuration parameters, wherein the initializing comprises activating the execution sequence, allocating specified resources, establishing a conversation state, and applying operational constraints;
executing, by the processor, the execution sequence of executable steps within the initialized execution environment, wherein each step comprises generating at least one of a model invocation request with specified parameters, a conversation context, authorized functions, and intermediate data, retrieving data from memory systems, integrating the retrieved data into the model invocation request;
invoking the Gen AI model for processing responses, and capturing performance metrics, executing authorized functions, validating inputs and outputs, and integrating results into the conversation state, and applying post-processing operations;
coordinating, by the processor, multi-agent interactions by managing agent communications and maintaining consistent conversation state during execution of the executable steps; and
generating, by the processor, a final result based on results of execution of the steps and coordinated multi-agent interactions by compiling an output, a conversation history, and execution metadata.

18. The method of claim 10, wherein generating the response to the user input based on the results of execution of the at least one task at the at least one AI agent comprises:
aggregating, by the processor, the results of execution by collecting intermediate artifacts, Large Language Model (LLM) responses, skill outputs, memory retrievals, and execution metadata generated during the ordered sequence of executable steps;
selecting, by the processor, a response type and an output template by mapping the at least one task type and explicit user requirements to a plurality of output targets, wherein the plurality of output targets comprise a human-readable formatted answer, a structured processed dataset, a machine-actionable payload, and a multi-section report;
generating, by the processor, an output content comprising at least one of the human-readable formatted answer, the structured processed dataset, the machine-actionable payload, and the multi-section report based on the selected response type and the output template;
embedding, by the processor, provenance data with the generated output content, wherein the provenance data comprises source identifiers, retrieval timestamps, skill identifiers, and confidence scores;
validating, by the processor, the generated content based on policy constraints, safety constraints, and sensitivity constraints by applying content-moderation filters, and masking rules for sensitive data, policy-based transformation rules, and provider-specific safety parameters;
re-validating, by the processor, the generated content with user-specified and system-imposed requirements by performing format validation check, completeness checks, and consistency checks with declared schema and data-typing rules;
determining, by the processor, a remediation action for the generated content based on results of validation, wherein the remediation action comprises attempting automated repair using predefined repair strategies, returning a diagnostic indicating a validation failure and recommending remediation steps;
performing, by the processor, post-processing operations on the generated content based on the determined remediation action, wherein the post-processing operations comprise at least one of rendering the generated content into user-requested output formats, generating and embedding visualizations by invoking visualization skills, and applying encryption to the generated content; and
generating, by the processor, a final response to the user input based on the performed post-processing operations, wherein the final response comprises at least one of a response payload in serialized formats, metadata, a bound Gen AI model family, a provider endpoint, a per-step and a cumulative token usage, timestamps, provenance data, identifiers for persisted intermediate artifacts and memory entries, and flags indicating applied policy transformations and validation status.

19. A non-transitory computer readable medium comprising a processor-executable instructions that cause a processor to:
receive a user input for performing at least one task from at least one data source, wherein the user input comprises at least one of a question, a workflow request, and an action;
determine a context and a plurality of operations required for performing the at least one task based on a task type, and metadata associated with the at least one task using an Artificial Intelligence (AI) model, wherein the metadata comprises domain information, policy information, and sensitivity information;
determine at least one AI agent to perform the at least one task based on the determined context, the task type, the metadata associated with the at least one task and the plurality of operations required for performing the at least one task;
determine a plurality of resources required for performing the at least one task based on the determined at least one AI agent and the plurality of operations required for performing the at least one task, wherein the plurality of resources comprise operational resources, network resources, computational resources, and data storage resources;
identify a Generative Artificial Intelligence (Gen AI) model and configuration parameters for the determined at least one AI agent based on the determined plurality of resources, wherein the configuration parameters comprise a model family, a context window, a temperature value, and safety settings;
determine an execution sequence for performing the at least one task based on the identified Gen AI model and the configuration parameters;
execute the at least one task at the at least one AI agent based on the determined execution sequence, the identified Gen AI model, and the configuration parameters;
generate a response to the user input based on results of execution of the at least one task at the at least one AI agent, wherein the response comprises at least one of a formatted answer, a processed dataset, an actionable output, a report, and wherein the response aligns with the task type and user requirements; and
output the generated response on a user interface of a user device.

20. The non-transitory computer readable medium of claim 19, wherein the processor-executable instructions cause the processor to:
determine a performance of the at least one AI agent based on results of execution using a set of predefined criteria, wherein the set of predefined criteria comprises a speed, an accuracy, a resource utilization, and an error rate; and
update a configuration of the at least one AI agent based on the determined performance, wherein the configuration comprises at least one of the configuration parameters of the Gen AI model, the execution sequence, and the plurality of resources.
